(19) United States
(12) Patent Application Publication
(10) Pub. No.: US 2026/0138056 A1
(43) Pub. Date: May 21, 2026

(54) In-Pipe Stormwater Treatment Unit Best Management Practice (I-STUB)

(71) Applicant: The United States of America, as represented by the Secretary of the Navy, Arlington, VA (US)

(72) Inventors: Brandon Lawson Swope, San Diego, CA (US); Patrick John Earley, San Diego, CA (US)

(21) Appl. No.: 18/979,268

(22) Filed: Dec. 12, 2024

Related U.S. Application Data
(60) Provisional application No. 63/722,196, filed on Nov. 19, 2024.

(51) Int. Cl. B01D 24/04; B01D 24/00; B01D 24/40; B01D 35/02; B01D 37/00; C02F 1/00; C02F 103/00

(52) U.S. Cl. CPC B01D 24/042; B01D 24/002; B01D 24/007; B01D 24/402; B01D 35/02; B01D 37/00; C02F 1/001; B01D 2201/10; B01D 2201/307; B01D 2201/4038; B01D 2201/4084; B01D 2201/4092; C02F 2103/001

(57) ABSTRACT

A filter for removing contaminants from stormwater comprising: a plurality of individual treatment units (ITUs), wherein each ITU includes a perforated filter body having an inlet end and an outlet end, wherein each ITU further includes a filter bag deployed within the perforated body and connected to the inlet end such that all stormwater entering the inlet end is channeled into the filter bag; and a plurality of rigid linkage arms, wherein each rigid linkage arm is configured to connect the inlet end of one ITU to the outlet end of a different ITU so as to form a chain of ITUs and rigid linkage arms, and wherein each linkage arm is configured to connect two given ITUs so as to limit side-to-side movement of the given ITUs with respect to each other.

This application claims priority to U.S. Provisional Application No. 63/722,196, filed 19 Nov. 2024, titled “In-Pipe Stormwater Treatment Unit Best Management Practice (I-STUB)” (Navy Case #212422).

### FEDERALLY-SPONSORED RESEARCH AND DEVELOPMENT

The United States Government has ownership rights in the invention claimed herein. Licensing and technical inquiries may be directed to the Office of Research and Technical Applications, Naval Information Warfare Center Pacific, Code 72110, San Diego, CA, 92152; voice (619) 553-5118; NIWC_Pacific_T2@us.navy.mil. Reference Navy Case Number 212422.

### BACKGROUND OF THE INVENTION

Urbanization and industrial activities have led to increased impervious surfaces, such as roads, rooftops, and parking lots, which significantly contribute to stormwater runoff. This runoff often carries various pollutants, including sediments, heavy metals, oils, and organic matter, from these surfaces into the stormwater drainage systems. Traditional stormwater management systems are primarily designed for flood control and often lack efficient mechanisms for pollutant removal. Consequently, untreated stormwater runoff can severely impact aquatic ecosystems, water quality, and public health. The need for effective stormwater management is underscored by stringent environmental regulations and growing awareness of water pollution issues. Current solutions, such as retention ponds, bioretention cells, and end-of-pipe treatment technologies, have limitations regarding space requirements, maintenance, and effectiveness. These traditional methods can be costly and challenging to retrofit in densely populated urban areas. There is a need for an improved stormwater filter.

### SUMMARY

Described herein is a filter for removing contaminants from stormwater comprising a plurality of individual treatment units (ITUs) and a plurality of rigid linkage arms. Each ITU includes a perforated filter body having an inlet end and an outlet end. Each ITU further includes a filter bag deployed within the perforated body and connected to the inlet end such that all stormwater entering the inlet end is channeled into the filter bag. Each rigid linkage arm is configured to connect the inlet end of one ITU to the outlet end of a different ITU so as to form a chain of ITUs and rigid linkage arms. Each linkage arm is configured to connect two given ITUs so as to limit side-to-side movement of the given ITUs with respect to each other.

An embodiment of a filter for removing contaminants from stormwater in a drainage system is also described herein as comprising a perforated body, a filter bag, a first cap, a capture cone, and a linkage arm. The perforated body has an inlet end and an outlet end, each of which has a receiving post. The first cap comprises an open end and an attachment end. The first cap is configured such that when the attachment end is attached to the perforated body's inlet end the filter bag is secured to the perforated body such that stormwater entering the inlet end is routed into the filter bag. The capture cone is configured to attach to the open end of the first cap. The capture cone is made of a flexible material that is able to conform to bottom contours of the drainage system. The linkage arm is rigid and configured to attach onto either of the receiving posts such that movement of the perforated body with respect to the linkage arm perpendicular to a long axis of the linkage arm is minimal.

Also disclosed herein is a method for removing contaminants from stormwater in a drainage system comprising the following steps. One step provides for positioning a first of a plurality of ITUs along a bottom surface of the drainage system. Each ITU of the plurality of ITUs includes a perforated filter body having an inlet end and an outlet end. Each ITU further includes a filter bag deployed within the perforated body and connected to the inlet end such that all stormwater entering the inlet end is channeled into the filter bag. Another step provides for attaching a first rigid linkage arm to the first ITU. The first rigid linkage arm is configured to attach to the first ITU such that movement of the first ITU's perforated body with respect to the first rigid linkage arm perpendicular to a long axis of the first rigid linkage arm is minimal. Another step provides for pushing the first ITU and the first rigid linkage arm into the drainage system. Another step provides for attaching the plurality of ITUs via a plurality of rigid linkage arms in a same manner as the first rigid linkage arm is attached to the first ITU so as to create a chain of ITUs and rigid linkage arms. Another step provides for pushing the chain of ITUs and rigid linkage arms into the drainage system one ITU or rigid linkage arm at a time as each ITU or rigid linkage arm is attached to the chain of ITUs and rigid linkage arms. Another step provides for securing an inlet end of the chain of ITUs and rigid linkage arms to an inlet of the drainage system. Another step provides for pulling the chain of ITUs and rigid linkage arms out of the inlet of the drainage system after the stormwater has passed through the chain of ITUs and rigid linkage arms.

### BRIEF DESCRIPTION OF THE DRAWINGS

Throughout the several views, like elements are referenced using like references. The elements in the figures are not drawn to scale and some dimensions are exaggerated for clarity.

FIG. 1 is a side-view illustration of one embodiment of a filter for removing contaminants from stormwater.

FIG. 2 is a perspective view of a disassembled embodiment of a filter for removing contaminants from stormwater.

FIG. 3A is a perspective, partial view of an inlet end of an embodiment of an ITU.

FIG. 3B is a perspective view of a hand holding an embodiment of a rigid linkage arm.

FIG. 4 is a perspective, partial view of an inlet end of an embodiment of an ITU.

FIG. 5 is a flowchart of a method for using a filter to remove contaminants from stormwater.

### DETAILED DESCRIPTION OF EMBODIMENTS

The disclosed systems and methods below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

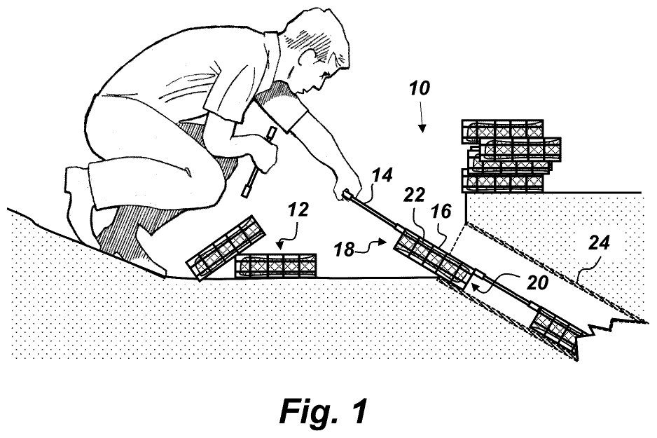

FIG. 1 is a side-view illustration of an embodiment of a filter 10 for removing contaminants from stormwater comprising, consisting of, or consisting essentially of a plurality of ITUs 12 and a plurality of rigid linkage arms 14. Each ITU 12 includes a perforated filter body 16 having an inlet end 18 and an outlet end 20. Each ITU further includes a filter bag 22 deployed within the perforated body 16 and connected to the inlet end 18 such that all stormwater entering the inlet end 18 is channeled into the filter bag 22. Each rigid linkage arm 14 is configured to connect the inlet end 18 of one ITU to the outlet end 20 of a different ITU 12 so as to form a chain of ITUs and rigid linkage arms. Each linkage arm 14 is configured to connect two given ITUs 12 so as to limit side-to-side movement of the given ITUs with respect to each other. Filter 10 allows for the removal of stormwater contaminants from within the drainage system itself, such as the outfall pipe 24 shown in FIG. 1. The linkage arms 14 are rigid, allowing the filter 10 to be pushed into the drainage system. Other examples of drainage systems, with which the filter 10 may be used, include, but are not limited to outfall pipes, discharge pipes, and open channels.

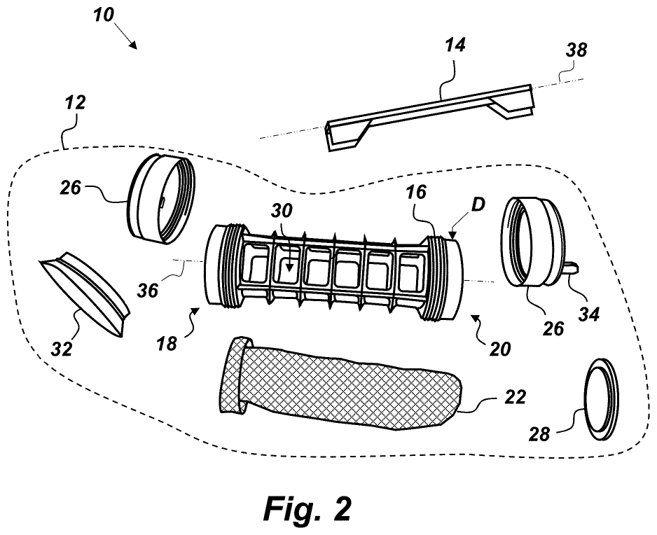

FIG. 2 is a perspective view of a disassembled embodiment of the filter 10. The perforated filter body 16 is able to contain the filter bag 22, which may be, for example, an industry standard size four filter bag of any desired mesh size that accommodates high flow. The filter bag 22 may be used to add media to the filter 10 to remove a wide variety of contaminants from stormwater in the drainage system as it flows through the filter 10. In the embodiment of filter 10 shown in FIG. 2, the perforated body 16 is cylindrical and symmetrical such that either end may function as the inlet end 18 or the outlet end 20. Although the perforated body 16 is shown in FIG. 2 as being cylindrical, it is to be understood that each ITU may have any desired size and shape. The filter bag 22 may be secured in place on either end of the perforated body 16 by an end cap 26, which, in this embodiment, is open and may be screwed to the perforated body 16. An end plate 28 may be attached to whichever end of the perforated body 16 that is serving as the outlet end 20. Using a given end cap 26 to attach the end plate 28 to the outlet end 20 converts the given end cap 26 into a closed end cap and directs stormwater entering the inlet end 18 to exit the ITU 12 through the perforations 30 in the perforated body 16. Also shown in FIG. 2 is a capture cone 32 designed to be attached to the end cap 26 that connects to the inlet end 18. The capture cone 32 is flexible and able to conform to contours of the bottom of a drainage system and helps direct additional stormwater into the ITU 12 for treatment.

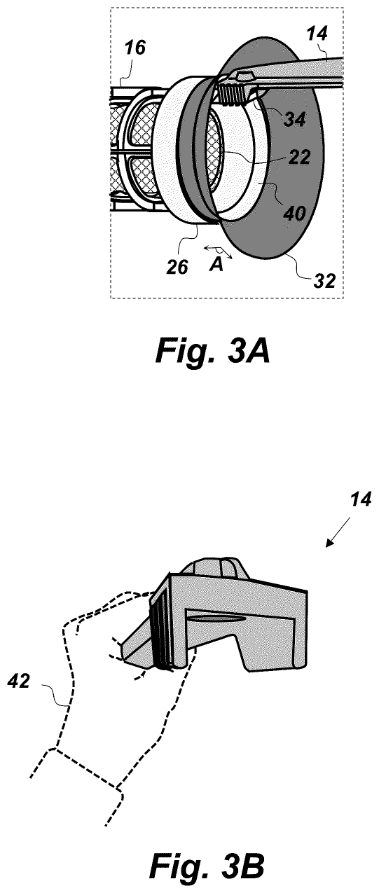

FIG. 3A is a perspective, partial view of the inlet end 18 of an embodiment of the ITU 12. In this embodiment, the linkage arm 14 is designed to be snapped onto a receiving post 34 (also depicted in FIG. 2), which is part of the end cap 26. The linkage arm 14 may be reinforced to limit side-to-side movement as well as up-and-down movement of the ITUs 12 with respect to each other when linked together. In other words, each linkage arm 14 may be configured to attach onto a separate receiving post 34 such that a long axis 36 of the perforated body 16 is kept approximately parallel to a long axis 38 of the linkage arm 14. This design reduces side-to-side movement of the ITUs 12 allowing for more effective deployment when pushing the ITUs 12 into the drainage system (such as shown in FIG. 1). The chain of ITUs 12 and rigid linkage arms 14 may be pushed into the drainage system one ITU 12 or one rigid linkage arm 14 at a time as each ITU 12 or rigid linkage arm 14 is attached to the chain of ITUs 12 and rigid linkage arms 14. The rigidity of the linkage arms 14 is useful when pushing the filter 10 into the drainage system 24. In the embodiment of the ITU 12 shown in FIG. 3, a leading lip 40 of the end cap 26 is beveled to match an angle A of the capture cone 32.

FIG. 3B is a perspective view of an end of an embodiment of the linkage arm 14 shown in FIG. 3A being held in a hand 42. In one example embodiment of the filter 10, each ITU 12 is approximately 45.72 cm (18 inches) long, with a diameter of approximately 11.43 cm (4.5 inches) or greater with perforations/windows 30 cut out along the longitudinal plane (as shown in FIG. 2) to allow maximum water flow while still providing structural support to the ITU 12. Different styles of filter bags 22 may be selected with different mesh sizes as desired. For example, it is preferable to have at least one filter bag selected with a focus on total suspended solids (TSS) and particulate metals removal. Other ITUs 12 may be equipped with filter bags 22 loaded with various media able to remove other contaminants such as dissolved metals and oil and grease from the stormwater. The mesh size and/or addition of media to the filter bags 22 and the ITU diameter D can be individualized to specific areas and contaminants, and outfall pipe diameter. The capture cone 32 may be removed from a cap 26 as desired. A series of multiple (e.g., 10-20) ITUs 12 can be attached with the rigid linkage arms 14 and deployed along a segment of pipe, depending on the outfall length. Ideally, the filter 10 should be deployed before a storm event(s), and retrieved after depending on the amount of precipitation. The ITUs 12 may be placed side-by-side along the bottom of an open channel drainage system in addition to within pipes.

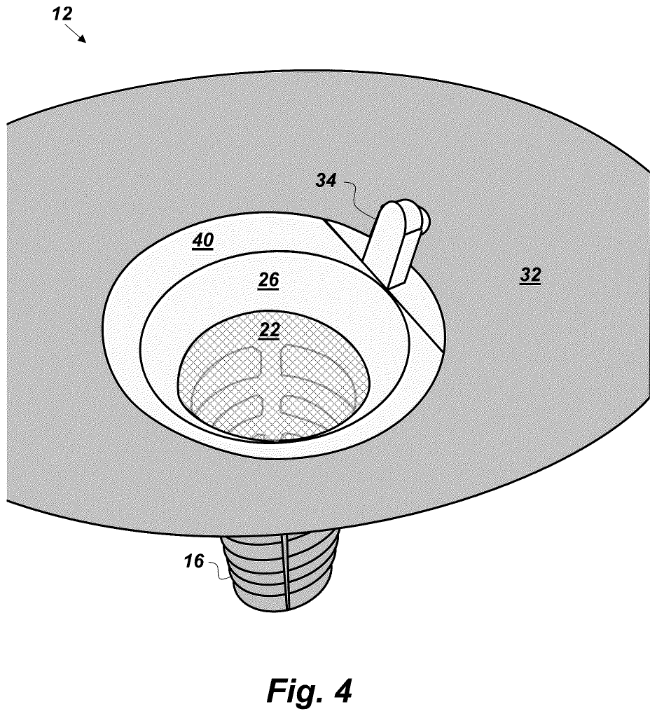

FIG. 4 is a perspective, partial view of the inlet end 18 of an embodiment of the ITU 12 showing the receiving post 34 as part of the end cap 26. The beveled leading lip 40 and the capture cone 32 are also depicted in FIG. 4. Different embodiments of the ITU 12 may be snapped together to form the filter 10. For example, some ITUs 12 may have media added to their corresponding filter bags 22 to absorb different contaminants, while other ITUs 12 in the chain can have filter bags with different mesh sizes to capture/filter and array of contaminants from the stormwater.

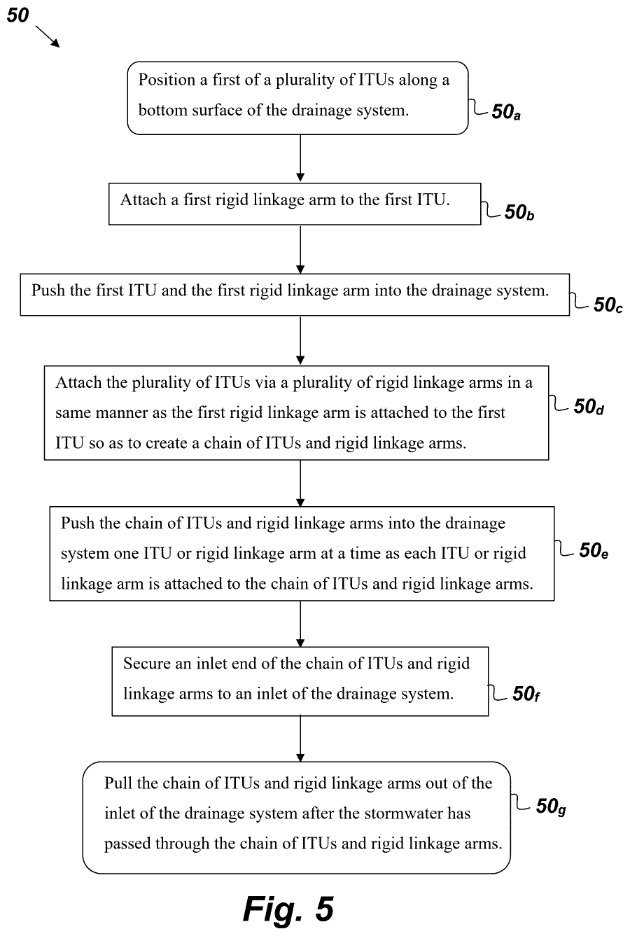

FIG. 5 is a flowchart of a method 50 for removing contaminants from stormwater in a drainage system comprising the following steps. One step 50ₐ provides for positioning a first of a plurality of ITUs along a bottom surface of the drainage system. Each ITU of the plurality of ITUs includes a perforated filter body having an inlet end and an outlet end, and each ITU further includes a filter bag deployed within the perforated body and connected to the inlet end such that all stormwater entering the inlet end is channeled into the filter bag. Another step 50b provides for attaching a first rigid linkage arm to the first ITU. The first rigid linkage arm is configured to attach to the first ITU such that movement of the first ITU's perforated body with respect to the first rigid linkage arm perpendicular to a long axis of the first rigid linkage arm is minimal (i.e., <10 degrees offset between the long axis of the ITU and the long axis of the linkage arm) Another step 50c provides for pushing the first ITU and the first rigid linkage arm into the drainage system. Another step 50d provides for attaching the plurality of ITUs via a plurality of rigid linkage arms in a same manner as the first rigid linkage arm is attached to the first ITU so as to create a chain of ITUs and rigid linkage arms. Another step 50e provides for pushing the chain of ITUs and rigid linkage arms into the drainage system one ITU or rigid linkage arm at a time as each ITU or rigid linkage arm is attached to the chain of ITUs and rigid linkage arms. Another step 50_{f} provides for securing an inlet end of the chain of ITUs and rigid linkage arms to an inlet of the drainage system. A last step 50_{g} provides for pulling the chain of ITUs and rigid linkage arms out of the inlet of the drainage system after the stormwater has passed through the chain of ITUs and rigid linkage arms.

From the above description of the filter 10, it is manifest that various techniques may be used for implementing the concepts of filter 10 without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that filter 10 is not limited to the particular embodiments described herein, but is capable of many embodiments without departing from the scope of the claims.

We claim:

1. A filter for removing contaminants from stormwater comprising:
a plurality of individual treatment units (ITUs), wherein each ITU includes a perforated filter body having an inlet end and an outlet end, wherein each ITU further includes a filter bag deployed within the perforated body and connected to the inlet end such that all stormwater entering the inlet end is channeled into the filter bag; and
a plurality of rigid linkage arms, wherein each rigid linkage arm is configured to connect the inlet end of one ITU to the outlet end of a different ITU so as to form a chain of ITUs and rigid linkage arms, and wherein each linkage arm is configured to connect two given ITUs so as to limit side-to-side movement of the given ITUs with respect to each other.

2. The filter of claim 1, wherein the perforated body of each ITU is cylindrical.

3. The filter of claim 2, wherein the perforated body of each ITU is symmetrical such that the inlet end and the outlet end are identical.

4. The filter of claim 3, wherein the inlet end and the outlet end of each ITU are open.

5. The filter of claim 4, wherein each ITU further comprises a closed end cap configured to be screwed onto the each ITU's outlet end such that when screwed on all stormwater entering the inlet end of the ITUs must exit through perforations in the perforated bodies of the ITUs.

6. The filter of claim 5, wherein the linkage arms are further configured to connect the ITUs together so as to limit up-and-down movement of the ITUs with respect to each other.

7. The filter of claim 6, wherein each ITU further comprises a capture cone configured to be attached to the inlet end of a corresponding ITU, wherein each capture cone comprises a flexible cone configured to conform to a bottom surface of a drainage system and to route stormwater flowing down the drainage system into an inlet end to which each capture cone is attached.

8. The filter of claim 7, wherein each linkage arm is at least 50% as long as each perforated body.

9. The filter of claim 8, wherein each ITU's filter bag is secured to the perforated body by an open cap that screws onto the perforated body, wherein the capture cone connects to the open cap, and wherein the open cap has a leading lip that is beveled to match an angle of the capture cone.

10. The filter of claim 9, wherein each linkage arm comprises two ends, wherein each end is configured to snap onto a receiving post on either the inlet end or the outlet end of one of the ITUs.

11. The filter of claim 7, wherein the drainage system is an open channel.

12. The filter of claim 11, further comprising at least one parallel ITU attached side-by-side to the chain of ITUs and rigid linkage arms.

13. A filter for removing contaminants from stormwater in a drainage system comprising:
a perforated body having an inlet end and an outlet end;
a filter bag;
a first cap comprising an open end and an attachment end, wherein the first cap is configured such that when the attachment end is attached to the perforated body's inlet end the filter bag is secured to the perforated body such that stormwater entering the inlet end is routed into the filter bag, and wherein the open end comprises a receiving post;
a capture cone configured to attach to the open end of the first cap, wherein the capture cone is made of a flexible material that is able to conform to bottom contours of the drainage system; and
a linkage arm that is rigid and configured to attach onto the receiving post such that movement of the perforated body with respect to the linkage arm perpendicular to a long axis of the linkage arm is minimal.

14. The filter of claim 13, further comprising a second cap identical to the first cap but configured to be attached to the perforated body's outlet end.

15. The filter of claim 14, further comprising a second linkage arm that is rigid and configured to attach onto the receiving post of the second cap such that movement of the perforated body with respect to the second linkage arm perpendicular to a long axis of the second linkage arm is minimal.

16. The filter of claim 15, further comprising an end plate configured to seal the open end of the second cap.

17. The filter of claim 16, wherein the first and second caps are configured to be screwed onto either the inlet end or outlet end of the perforated body.

18. The filter of claim 13, wherein capture cone surrounds the receiving post.

19. The filter of claim 13, wherein the drainage system is an open channel.

20. A method for removing contaminants from stormwater in a drainage system comprising:
positioning a first of a plurality of individual treatment units (ITUs) along a bottom surface of the drainage system, wherein each ITU of the plurality of ITUs includes a perforated filter body having an inlet end and an outlet end, and wherein each ITU further includes a filter bag deployed within the perforated body and connected to the inlet end such that all stormwater entering the inlet end is channeled into the filter bag;
attaching a first rigid linkage arm to the first ITU, wherein the first rigid linkage arm is configured to attach to the first ITU such that movement of the first ITU's perforated body with respect to the first rigid linkage arm perpendicular to a long axis of the first rigid linkage arm is minimal;
pushing the first ITU and the first rigid linkage arm into the drainage system;
attaching the plurality of ITUs via a plurality of rigid linkage arms in a same manner as the first rigid linkage arm is attached to the first ITU so as to create a chain of ITUs and rigid linkage arms;
pushing the chain of ITUs and rigid linkage arms into the drainage system one ITU or rigid linkage arm at a time as each ITU or rigid linkage arm is attached to the chain of ITUs and rigid linkage arms;
securing an inlet end of the chain of ITUs and rigid linkage arms to an inlet of the drainage system; and
pulling the chain of ITUs and rigid linkage arms out of the inlet of the drainage system after the stormwater has passed through the chain of ITUs and rigid linkage arms.
